(19) United States
(12) Patent Application Publication
(10) Pub. No.: US 2016/0234394 A1
(43) Pub. Date: Aug. 11, 2016

(54) DISPLAY INPUT DEVICE AND IMAGE FORMING APPARATUS INCLUDING SAME, AND METHOD FOR CONTROLLING DISPLAY INPUT DEVICE

(71) Applicant: KYOCERA Document Solutions Inc., Osaka (JP)

(72) Inventor: Kazuhiko MIYAMOTO, Osaka (JP)

(73) Assignee: KYOCERA Document Solutions Inc., Osaka (JP)

(21) Appl. No.: 15/013,619

(22) Filed: Feb. 2, 2016

(30) Foreign Application Priority Data
Feb. 5, 2015 (JP) 2015-021302

(51) Int. Cl. H04N 1/00

(52) U.S. Cl. CPC H04N 1/00474; H04N 1/00411; H04N 1/0032; H04N 2201/0094

(57) ABSTRACT

A display input device includes a display unit, a touch panel unit, a control unit, and a storage unit that stores therein number-of-times information that indicates number of times each of previously determined soft keys has been used. When a frequently-used key display operation is performed on the touch panel unit, the control unit selects soft keys ranging from a soft key of the highest order that has been used the largest number of times to a soft key of a predetermined order as frequently-used keys, and the display unit collectively displays the frequently-used keys on a currently displayed screen.

### INCORPORATION BY REFERENCE

This application is based upon and claims the benefit of priority from the corresponding Japanese Patent Application No. 2015-021302 filed on Feb. 5, 2015, the entire contents of which are incorporated herein by reference.

### BACKGROUND

The present disclosure relates to a display input device and an image forming apparatus including the same, and also relates to a method for controlling a display input device.

Conventionally, there have been know display input devices installed in, for example, image forming apparatuses. For example, conventional display input devices each include a touch panel display, and are installed in multifunction peripherals equipped with a plurality of kinds of functions including a copy function. Via the touch panel display, the conventional display input devices accept settings inputted by a user regarding the copy function including settings for sheet size, magnification, density, the number of copies to be made, and the like.

### SUMMARY

According to a first aspect of the present disclosure, a display input device includes a display unit, a touch panel unit, a control unit, and a storage unit. The display unit displays a screen. The touch panel unit is a unit for detecting a touch operation performed on the screen displayed on the display unit. Based on an output of the touch panel unit, the control unit detects a touch operation performed on the screen displayed on the display unit, and makes the display unit switch the screen to another screen. The storage unit stores therein number-of-times information that indicates number of times each of previously determined soft keys has been used. When a frequently-used key display operation which is a touch operation of touching a plurality of points on the screen displayed on the display unit is performed on the touch panel unit, the control unit selects, based on the number-of-times information, soft keys ranging from a soft key of the highest order that has been used the largest number of times to a soft key of a predetermined order as frequently-used keys, and the display unit collectively displays the frequently-used keys on the screen that is currently displayed.

According to a second aspect of the present disclosure, an image forming apparatus includes the display input device described above.

According to a third aspect of the present disclosure, a method for controlling a display input device includes the steps of selecting soft keys ranging from a soft key of the highest order that has been used the largest number of times to a soft key of a predetermined order as frequently-used keys from among previously determined soft keys based on number-of-times information that indicates number of times each of the predetermined soft keys has been used, when a frequently-used key display operation is performed which is a touch operation of touching a plurality of points on a screen, and collectively displaying the frequently-used keys on the screen that is currently displayed.

### BRIEF DESCRIPTION OF THE DRAWINGS

FIG. 1 is a diagram showing an example of a multifunction peripheral according to an embodiment of the present disclosure;

FIG. 2 is a diagram showing an example of an operation panel according to an embodiment of the present disclosure;

FIG. 3 is a diagram showing an example of a hardware configuration of a multifunction peripheral (an operation panel) according to an embodiment of the present disclosure;

FIG. 4 is a diagram showing an example of a screen (an item selection screen for a copy function) displayed on an operation panel according to an embodiment of the present disclosure;

FIG. 5 is a diagram showing an example of a screen (an item selection screen for a transmission function) displayed on an operation panel according to an embodiment of the present disclosure;

FIG. 6 is a diagram showing an example of a screen (an advanced setting screen for sheet selection) displayed on an operation panel according to an embodiment of the present disclosure;

FIG. 7 is a diagram showing an example of a screen (an advanced setting screen for document size) displayed on an operation panel according to an embodiment of the present disclosure;

FIG. 8 is a diagram showing an example of a screen (an item selection screen for a copy function) displayed on an operation panel according to an embodiment of the present disclosure;

FIG. 9 is a diagram for illustrating an example of a frequently-used key display operation performed on an operation panel according to an embodiment of the present disclosure;

FIG. 10 is a diagram showing an example of a screen displayed when a frequently-used key display operation is performed on an operation panel according to an embodiment of the present disclosure;

FIG. 11 is a diagram showing an example of a screen displayed when a frequently-used key display operation is performed on an operation panel according to an embodiment of the present disclosure;

FIG. 12 is a diagram showing an example of a screen displayed when a frequently-used key display operation is performed on an operation panel according to an embodiment of the present disclosure;

FIG. 13 is a diagram for illustrating an example of a frequently-used key display operation performed on an operation panel according to an embodiment of the present disclosure;

FIG. 14 is a diagram for illustrating an operation performed when switching from an item selection screen (a screen on which frequently-used keys are collectively displayed) to an advanced setting screen on an operation panel according to an embodiment of the present disclosure;

FIG. 15 is a diagram for illustrating an operation performed when switching from an item selection screen (a screen on which collective display of frequently-used keys is performed) to an advanced setting screen (a screen on which collective display of frequently-used keys is not performed) on an operation panel according to an embodiment of the present disclosure;

FIG. 16 is a diagram for illustrating an example of an operation performed when finishing collectively displaying frequently-used keys on an operation panel according to an embodiment of the present disclosure; and

FIG. 17 is a flowchart for illustrating a flow of control performed when collectively displaying frequently-used keys on an operation panel according to an embodiment of the present disclosure.

### DETAILED DESCRIPTION

Hereinafter, descriptions will be given of an image forming apparatus according to an embodiment of the present disclosure, taking as an example a multifunction peripheral equipped with a plurality of kinds of functions such as a copy function and a transmission function (a fax function).

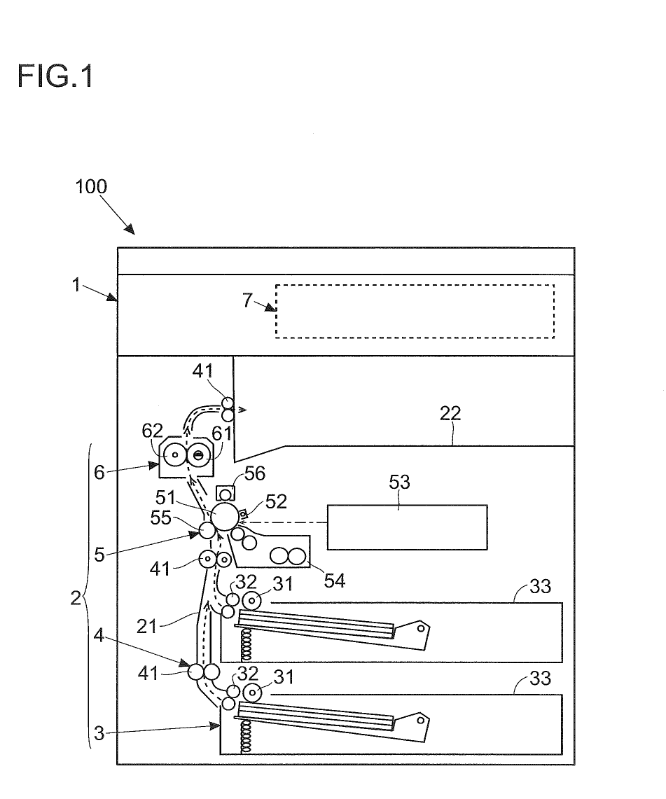

Overall Configuration of Multifunction Peripheral: As illustrated in FIG. 1, a multifunction peripheral 100 (equivalent to “an image forming apparatus”) includes an image reading unit 1 and a printing unit 2. The image reading unit 1 reads a document and generates image data of the document. The printing unit 2 conveys a sheet along a sheet conveying path 21, and forms a toner image based on the image data. Then, the printing unit 2 transfers (prints) the toner image onto the sheet under conveyance, and delivers the printed sheet to a delivery tray 22.

The printing unit 2 is constituted of a sheet feeding unit 3, a sheet conveying unit 4, an image forming unit 5, and a fixing unit 6. The sheet feeding unit 3 includes a pickup roller 31 and sheet feeding roller pair 32, and supplies a sheet stored in sheet cassettes 33 to the sheet conveying path 21. The sheet conveying unit 4 includes a plurality of conveyance roller pairs 41, and conveys a sheet along the sheet conveying path 21.

The image forming unit 5 includes a photosensitive drum 51, a charging device 52, an exposing device 53, a developing device 54, a transfer roller 55, and a cleaning device 56. The image forming unit 5 forms a toner image based on image data, and transfers the toner image onto a sheet. The fixing unit 6 includes a heat roller 61 and a pressure roller 62, and applies heat and pressure to the toner image transferred onto the sheet, to thereby fix the toner image.

The multifunction peripheral 100 further includes an operation panel 7. The operation panel 7 is disposed on a front-face side (at a portion indicated by a broken line) of the multifunction peripheral 100. The operation panel 7 is equivalent to “a display input device”.

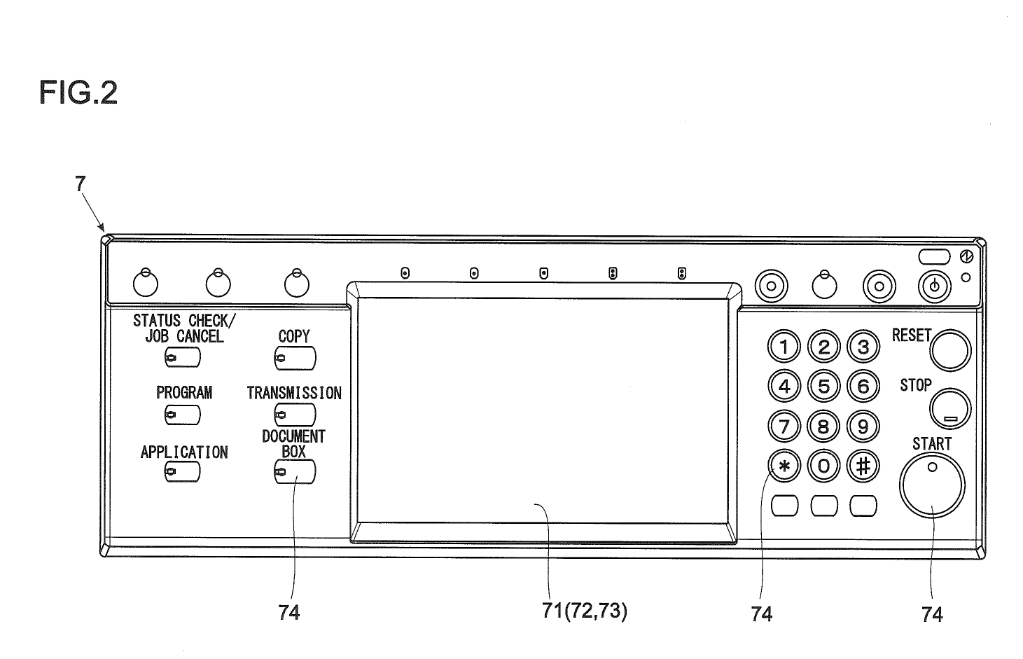

As illustrated in FIG. 2, the operation panel 7 is provided with an operation display unit 71 (a touch panel display). The operation display unit 71 includes a display unit 72 and a touch panel unit 73. The display unit 72 is a display panel such as a liquid crystal display panel or an organic EL display panel. The touch panel unit 73 is a touch panel that is capable of simultaneously detecting a plurality of touch positions (and thus is referred to as a multi-touch panel, for example), and the touch panel unit 73 is disposed so as to cover a display surface of the display unit 72. At the operation display unit 71, soft keys for accepting inputs of various settings, messages, and the like are displayed on the display unit 72, and various settings inputted via the touch panel unit 73 are accepted. Here, the operation panel 7 is provided also with various hard keys 74, such as a start key, a stop key, a reset key, and a ten-key pad.

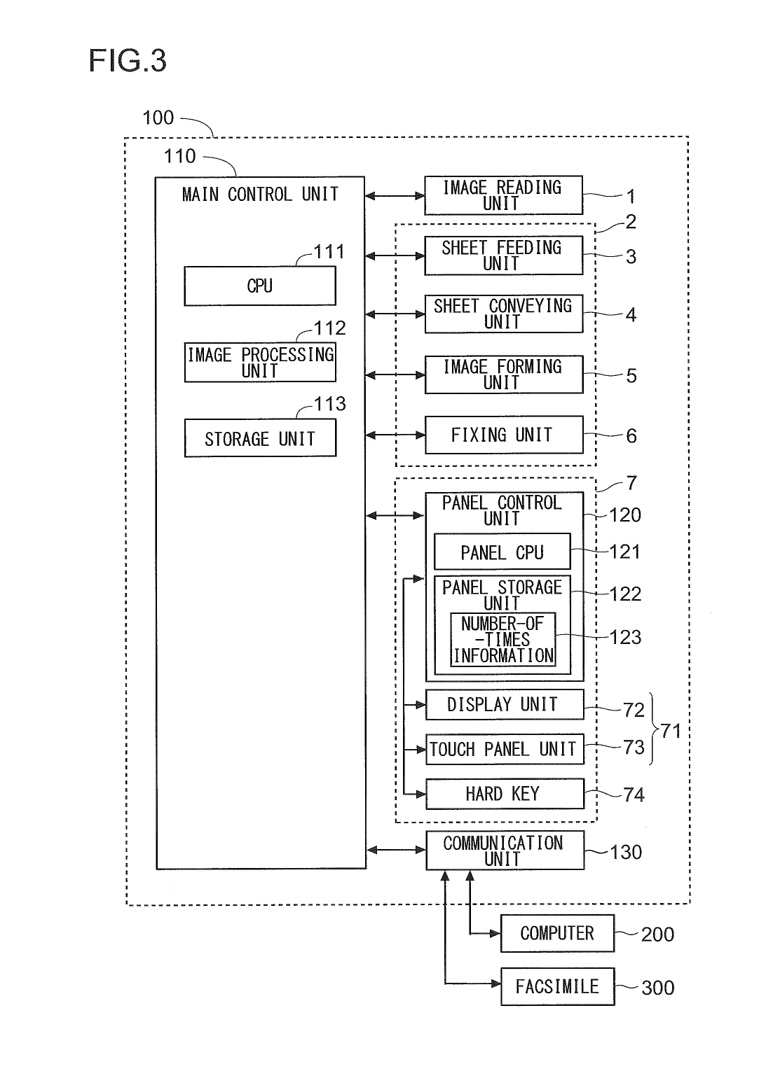

Hardware Configuration of Multifunction Peripheral: As illustrated in FIG. 3, the multifunction peripheral 100 includes a main control unit 110. The main control unit 110 includes a CPU 111, an image processing unit 112, and a storage unit 113. The image processing unit 112 is constituted by, for example, an ASIC dedicated for image processing, and performs image processing (expansion/reduction, density conversion, data format conversion, etc.) on image data. The storage unit 113 is constituted by a ROM and a RAM, for example, and stores therein a program and data for control. The main control unit 110 controls operations of the image reading unit 1 and the printing unit 2 (the sheet feeding unit 3, the sheet conveying unit 4, the image forming unit 5, and the fixing unit 6) based on the program and the data stored in the storage unit 113.

Further, the main control unit 110 is connected to a panel control unit 120. The panel control unit 120 includes a panel CPU 121 and a panel storage unit 122; for example, the panel control unit 120 receives instructions from the main control unit 110 and controls a display operation of the display unit 72, and detects a touch operation performed on a screen displayed on the display unit 72, based on an output of the touch panel unit 73. The panel control unit 120 also detects an operation performed on the hard keys 74. The panel control unit 120 (the CPU 121) is equivalent to “a control unit”. Here, the panel storage unit 122 includes memories such as a ROM and a RAM.

For example, the panel control unit 120 makes the display unit 72 display a screen where a soft key and the like are arranged, and when a touch operation is performed on the soft key, the panel control unit 120 detects, based on the output of the touch panel unit 73, the soft key on which the touch operation has been performed. Then, the panel control unit 120 makes the display unit 72 display a screen corresponding to the detected soft key.

The main control unit 110 is connected also to a communications unit 130. The communication unit 130 is communicably connected to an external computer 200 via a network. This makes it possible to perform printing based on image data transmitted from the computer 200, and also to transmit to the computer 200 image data obtained by the image reading unit 1 by reading a document. Further, a modem or the like may be incorporated in the communication unit 130. In this case, fax communication is able to be performed with an external facsimile 300 via a network such as a telephone line.

Screen Displayed on Operation Panel: When a main power supply is turned on, the operation panel 7 displays an unillustrated main menu screen (an initial screen). Then, the operation panel 7 accepts a selection instruction inputted by the user regarding which of the plurality kinds of functions of the multifunction peripheral 100 is to be used.

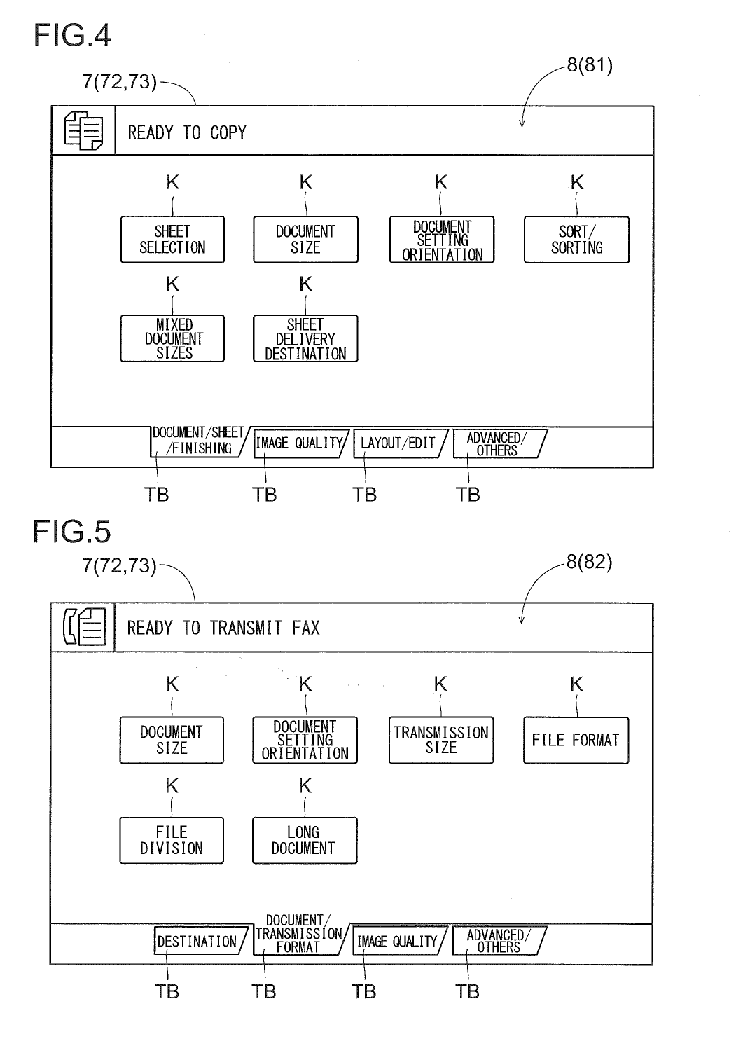

When the function to be used is selected on the main menu screen, the operation panel 7 displays an item selection screen 8 (see FIGS. 4 and 5). On this item selection screen 8, there are arranged item selection keys K for accepting selection inputted by the user regarding which of a plurality of setting items a setting detail (a setting value) is to be set for. For example, when the copy function is selected as the function to be used, the operation panel 7 displays an item selection screen 81 as illustrated in FIG. 4, and on the other hand, when the transmission function is selected as the function to be used, the operation panel 7 displays an item selection screen 82 as illustrated in FIG. 5. Here, the item selection keys K are equivalent to “soft keys”. A detailed description will be given below by taking as an example the item selection screen 8 (81) for the copy function.

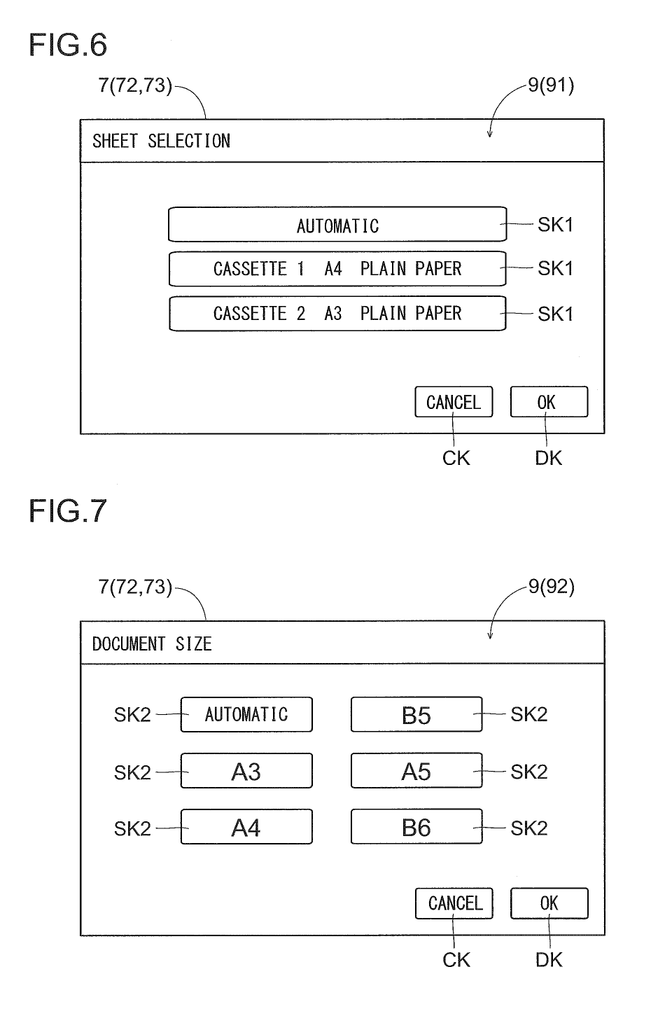

In the setting screen 81 for the copy function, as illustrated in FIG. 4, there are arranged a plurality of item selection keys K respectively corresponding to a plurality of setting items for the copy function. FIG. 4 illustrates, as examples, a plurality of item selection keys K respectively corresponding to “sheet selection”, “document size”, “document setting orientation”, “sort/sorting”, “mixed document sizes”, and “sheet delivery destination”. Then, on accepting a touch operation on any of the item selection keys K, the operation panel 7 displays an advanced setting screen 9 (see FIG. 6 and FIG. 7) which is a screen for accepting an input of a setting for the setting item corresponding to the item selection key K that has received the touch operation, and which is also a screen one level below the item selection screen 81.

For example, when a touch operation is performed on a “sheet selection” key among the item selection keys K, the operation panel 7 displays an advanced setting screen 91 on which a plurality of sheet selection keys SK1 are arranged as illustrated in FIG. 6. The advanced setting screen 91 is for setting the size of a sheet to be used in printing (that is, one of the sheet cassettes 33 from which a sheet is to be supplied). For example, when the user touches a “cassette 1 (A4)” key among the sheet selection keys SKI, the size of a sheet to be used for printing is set to the A4 size.

When, a touch operation is performed on a “document size” key among the item selection keys K on the item selection screen 81, the operation panel 7 displays an advanced setting screen 92 where a plurality of document size selection keys SK2 are arranged as illustrated in FIG. 7. The advanced setting screen 92 is for setting a document reading size. For example, when the user touches an “A4” key among the document size selection keys SK2, the reading size of the document to be read is set to the A4 size.

Here, on the advanced-setting screen 9, there are arranged an OK key DK and a cancel key CK. When the user touches the OK key DK, the details set on the advanced-setting screen 9 are confirmed, and the displayed screen is switched from the advanced-setting screen 9 to the item selection screen 8. When the user touches the cancel key CK, the details set on the advanced-setting screen 9 are canceled.

Here, there are many more setting items for the copy function in addition to “sheet selection”, “document size”, “document setting orientation”, “sort/sorting”, “mixed document sizes”, and “sheet delivery destination”. Examples of such additional setting items are “density”, “document image quality”, “sharpness”, “backside stain prevention”, “eco print”, “ground color adjustment”, “reduction/enlargement”, “page aggregation”, “continuous reading”, “automatic image rotation”, “black/white reverse”, “job end notification”, “document name input”, “recopy”, etc. Thus, as illustrated in FIG. 4, a plurality of tabs TB is disposed on the item selection screen 81.

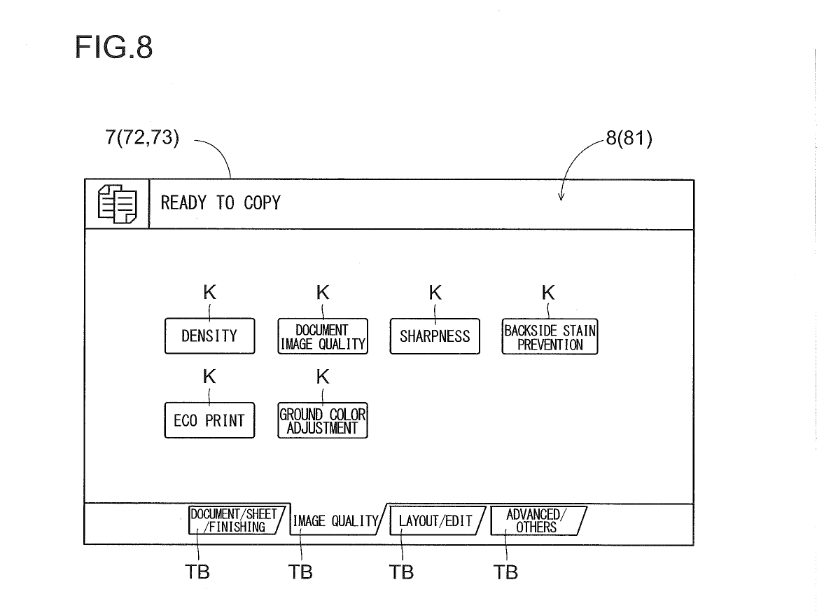

On accepting a touch operation on any of the plurality of tabs TB, the operation panel 7 displays the item selection screen 8 corresponding to the tab TB that has received the touch operation. For example, the item selection screen 81 illustrated in FIG. 4 is one corresponding to a “document/sheet/finish” tab TB. When a touch operation is performed on an “image quality” tab TB while the item selection screen 81 illustrated in FIG. 4 is displayed, the operation panel 7 switches the displayed screen from the item selection screen 81 illustrated in FIG. 4 to another item selection screen 81 which is illustrated in FIG. 8.

The item selection keys K arranged on the item selection screen 81 illustrated in FIG. 8 correspond to setting items regarding “image quality”, and thus are different from the item selection keys K arranged on the item selection screen 81 illustrated in FIG. 4. FIG. 8 illustrates as an example a plurality of item selection keys K respectively corresponding to “density”, “document image quality”, “sharpness”, “backside stain prevention”, “eco print”, and “ground color adjustment”. And, also in a case where a touch operation has been performed on any of the plurality of item selection keys K, the operation panel 7 displays the advanced setting screen 9 (corresponding screen is unillustrated) for accepting a setting for the item corresponding to the item selection key K that has received the touch operation.

Collective Display of Frequently-Used Keys: In the present embodiment, the number of times each of the item selection keys K has been used (the number of times each of the item selection keys K has received a touch operation via the touch panel unit 73) is stored. For example, number-of-times information 123 indicating the number of times each of the item selection keys K has been used is stored in the panel storage unit 122 (a memory) (see FIG. 3).

Then, when a frequently-used key display operation, which is a previously determined touch operation, is performed on the touch panel unit 73, the panel control unit 120 selects frequently used ones of the plurality of item selection keys K as frequently-used keys (sometimes denoted by a sign MK in the following description) based on the number-of-times information 123, and makes the display unit 72 collectively display all of the selected frequently-used keys MK. Now, a detailed description will be given below, taking the item selection screen 8 (81) for the copy function as an example. In the following description, it is assumed that the item selection screen 8 illustrated in FIG. 4 has been displayed until immediately before the frequently-used key display operation is received.

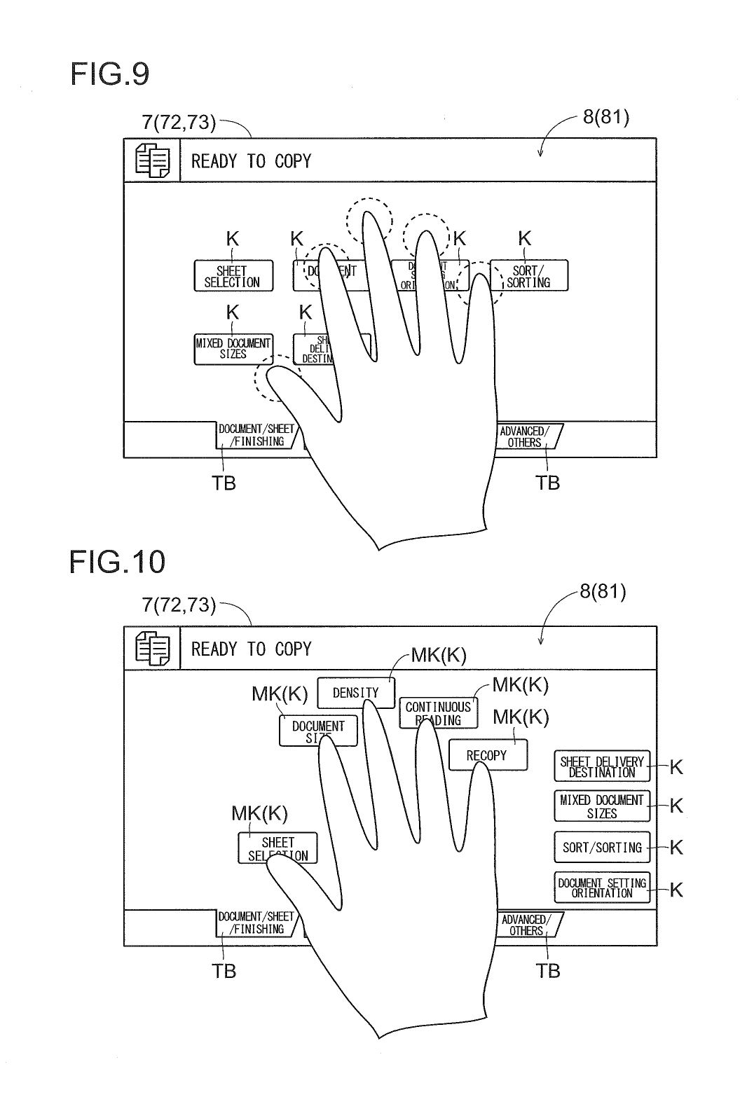

The panel control unit 120 judges whether or not a frequently-used key display operation has been performed on the touch panel unit 73 during the display of the item selection screen 8 by the display unit 72. Specifically, when the touch panel unit 73 accepts a touch operation of simultaneously touching five points (indicated by broken lines in FIG. 9) on the screen displayed on the display unit 72 as illustrated in FIG. 9, the panel control unit 120 judges that a frequently-used key display operation has been performed on the touch panel unit 73. Note that there is no specific limitation to the touch operation to be accepted as the frequently-used key display operation. For example, the frequently-used key display operation may be a touch operation of simultaneously touching two to four points on the touch panel unit 73.

When such a frequently-used key display operation is performed on the touch panel unit 73, the panel control unit 120 determines the number of times each of the plurality of item selection keys K has been used, based on the number-of-times information 123. Then, the panel control unit 120 selects, from among the plurality of item selection keys K, item selection keys K ranging from an item selection key K of the highest order that has been used the largest number of times to an item selection key K of a predetermined order as frequently-used keys MK. In other words, the panel control unit 120 selects from the plurality of item selection keys K the top N most frequently-used item selection keys K as frequently-used keys MK, N being a previously determined natural number greater than one.

For example, when the touch operation of simultaneously touching five points has been determined as the frequently-used key display operation, the five most frequently used item selection keys K are selected as the frequently-used keys MK. When a touch operation of simultaneously touching four points has been determined as the frequently-used key display operation, the four most frequently used item selection keys K are selected as the frequently-used keys MK.

Here, the number of item selection keys K to be selected as frequently-used keys MK is not limited to a specific number, and may be changed as necessary. For example, even when the touch operation of simultaneously touching five points has been determined as the frequently-used key display operation, the number of item selection keys K selected as frequently-used keys MK may be four or smaller, or may be six or larger.

After selecting the frequently-used keys MK, the panel control unit 120 makes the display unit 72 perform collective display of all the selected frequently-used keys M as illustrated in FIG. 10. At this time, the display unit 72 displays the frequently-used keys MK, which have been selected by the panel control unit 120, on the currently displayed item selection screen 8 in such a manner that the selected frequently-used keys MK are each positioned on one of touch points (five points) which have been touched by the user in the frequently-used key display operation. FIG. 10 illustrates an example where the item selection keys K corresponding to “sheet selection”, “document size”, “density”, “continuous reading”, and “recopy” are selected as frequently-used keys MK. The display unit 72 also moves the other item selection keys K (the item selection keys K corresponding to “document setting orientation”, “sort/sorting”, “mixed document sizes”, and “sheet delivery destination”), which have not been selected as the frequently-used keys MK, so as not to overlap with the frequently-used keys MK.

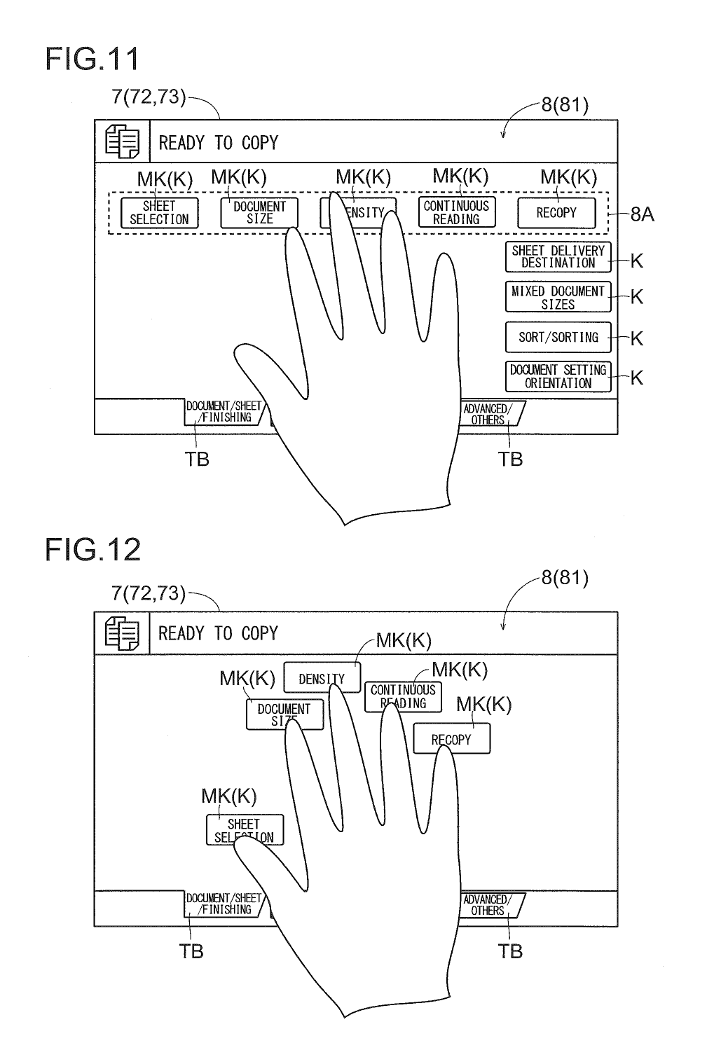

In another example, when collectively displaying the frequently-used keys MK on the currently displayed item selection screen 8, the frequently-used keys MK may be arranged within a previously determined display area 8A (for example, an area in an upper portion of the item selection screen 8) as illustrated in FIG. 11.

Alternatively, when collectively displaying the frequently-used keys MK on the currently displayed item selection screen 8, display of the other item selection keys K that have not been selected as frequently-used keys MK may be omitted as illustrated in FIG. 12. Still alternatively, although not illustrated, the item selection keys K other than the frequently-used keys MK may be displayed in a mutually overlapping or superposed manner or in a grayed-out manner.

Here, since the item selection keys K corresponding to the setting items of “density”, “continuous reading”, and “recopy” have not been displayed on the item selection screen 8 (the screen illustrated in FIG. 4) that has been displayed immediately before the acceptance of the frequently-used key display operation. That is, these item selections keys K are ones to be displayed on an item selection screen 8 that is different from the currently displayed item selection screen 8. However, in such a case, too, the display unit 72 displays all the frequently-used keys MK selected by the panel control unit 120 on the currently displayed item selection screen 8.

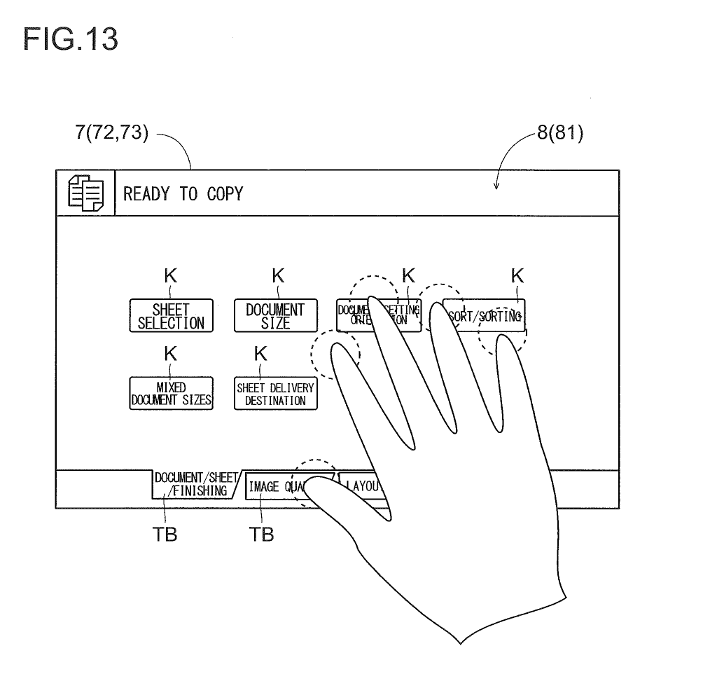

Here, as illustrated in FIG. 13, when any of the five touch positions touched in the frequently-used key display operation is a position where one of the tabs TB is displayed, frequently-used keys MK may be selected from among the item selection keys K to be displayed on the item selection screen 8 corresponding to the touched tab TB. In this case, when the “image quality” tab TB is touched, frequently-used keys MK are selected from among options of six item selection keys K (see FIG. 8) corresponding to the setting items of “density”, “document image quality”, “sharpness”, “backside stain prevention”, “eco print”, and “ground color adjustment”, and the item selection keys K other than the six item selection keys K are not included in the options. Accordingly, item selection keys K other than the six item selection keys K are not to be selected (displayed) as frequently-used key MK.

Alternatively, when any of the five touch positions touched in the frequently-used key display operation is a position where one of the tabs TB is displayed, frequently-used keys MK may be selected from among the item selection keys K other than the item selection keys K to be displayed on the item selection screen 8 corresponding to the touched tab TB. In this case, when the “image quality” tab TB is touched, frequently-used keys MK are selected from among options of item selection keys K other than the six item selection keys K (see FIG. 8) corresponding to the setting items of “density”, “document image quality”, “sharpness”, “backside stain prevention”, “eco print”, and “ground color adjustment”, and the six item selection keys K are not included in the options. Accordingly, the six item selection keys K are not to be selected (displayed) as frequently-used key MK.

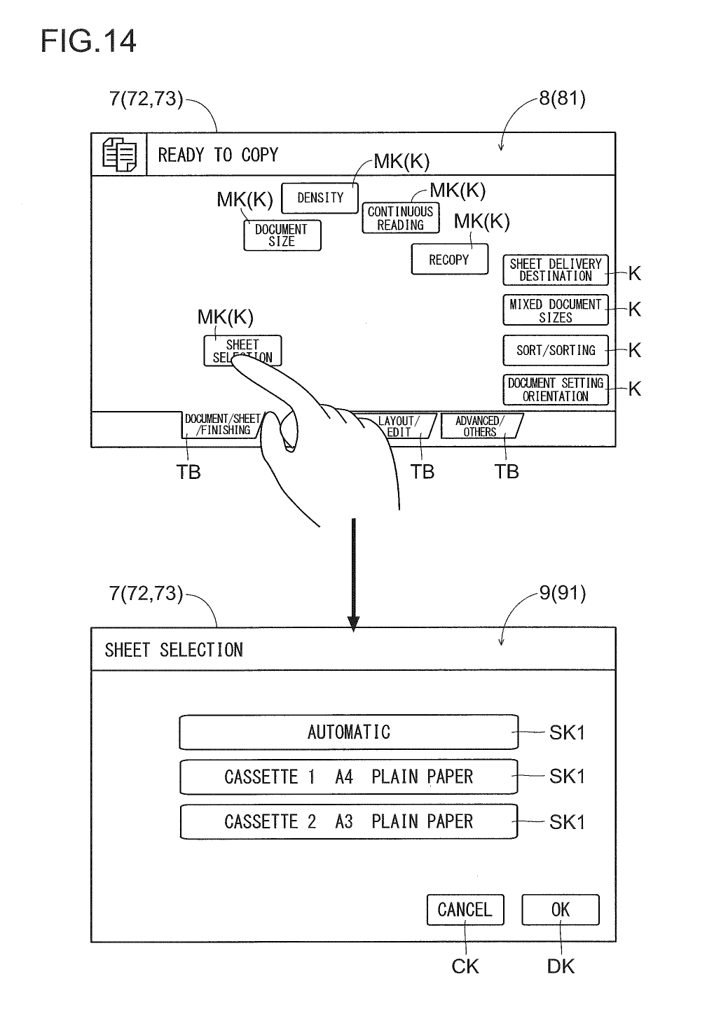

Even when touches on the five points performed in the frequently-used key display operation are released after the collective display of the frequently-used keys MK, the panel control unit 120 makes the display unit 72 continue the collective display of the frequently-used keys MK. Then, when a touch operation is performed on any of the frequently-used keys MK while the item selection screen 8 on which the frequently-used keys MK are collectively displayed is being displayed as illustrated in FIG. 14, the panel control unit 120 makes the display unit 72 display an advanced setting screen 9 (see FIG. 6 and FIG. 7) corresponding to the frequently-used key MK on which the touch operation has been performed. For example, when a touch operation has been performed on a “sheet selection” item selection key K (a frequently-used key MK), the display unit 72 displays an advanced setting screen 91 for accepting an input of a setting of the size of a sheet to be used in printing.

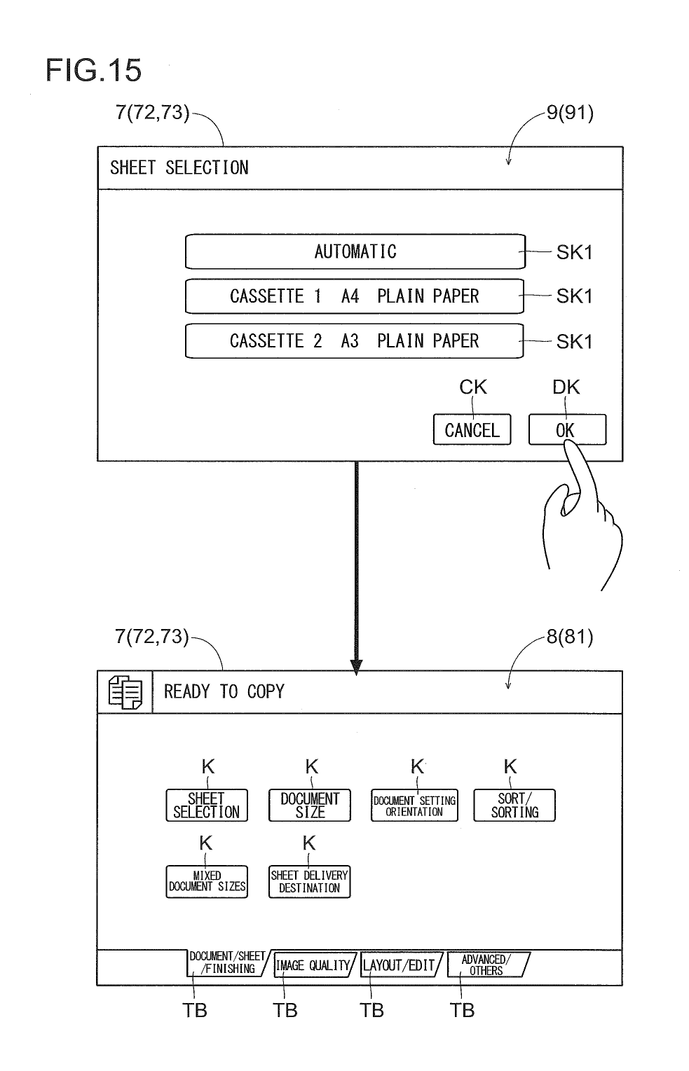

Thereafter, when a setting-completing operation (a touch operation on the OK key DK) is performed on the advanced setting screen 9, the panel control unit 120 makes the display unit 72 display the item selection screen 8 (the original screen) that has been displayed until immediately before the acceptance of the frequently-used key display operation, as illustrated in FIG. 15. At this time, the display unit 72 does not perform collective display of the frequently-used keys MK. That is, the layout of the item selection screen 8 displayed at this time is the same as the screen layout immediately before the acceptance of the frequently-used key display operation.

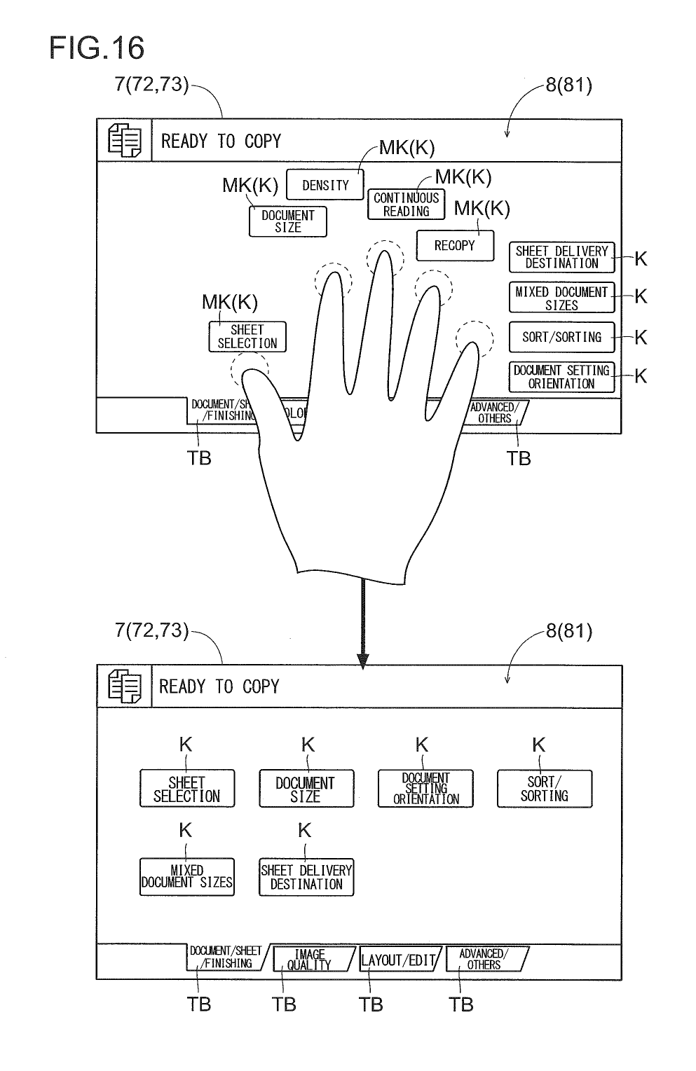

The panel control unit 120 also judges whether or not a touch operation previously determined as an end operation has been performed on the touch panel unit 73 during the display of the item selection screen 8 by the display unit 72, with the frequently-used keys MK collectively displayed on the item selection screen 8. For example, when the touch panel unit 73 accepts the same operation as the frequently-used key display operation again while the display unit 72 is displaying the item selection screen 8 on which the frequently-used keys MK are collectively displayed, the panel control unit 120 judges that an end operation has been performed on the touch panel unit 73. When an end operation is performed on the touch panel unit 73, the panel control unit 120 makes the display unit 72 finish the collective display of the frequently-used keys MK, as illustrated in FIG. 16 (in FIG. 16, touch points touched in the end operation are indicated by broken lines). That is, the display unit 72 displays an item selection screen 8 having the same layout as the screen displayed immediately before the acceptance of the frequently-used key display operation.

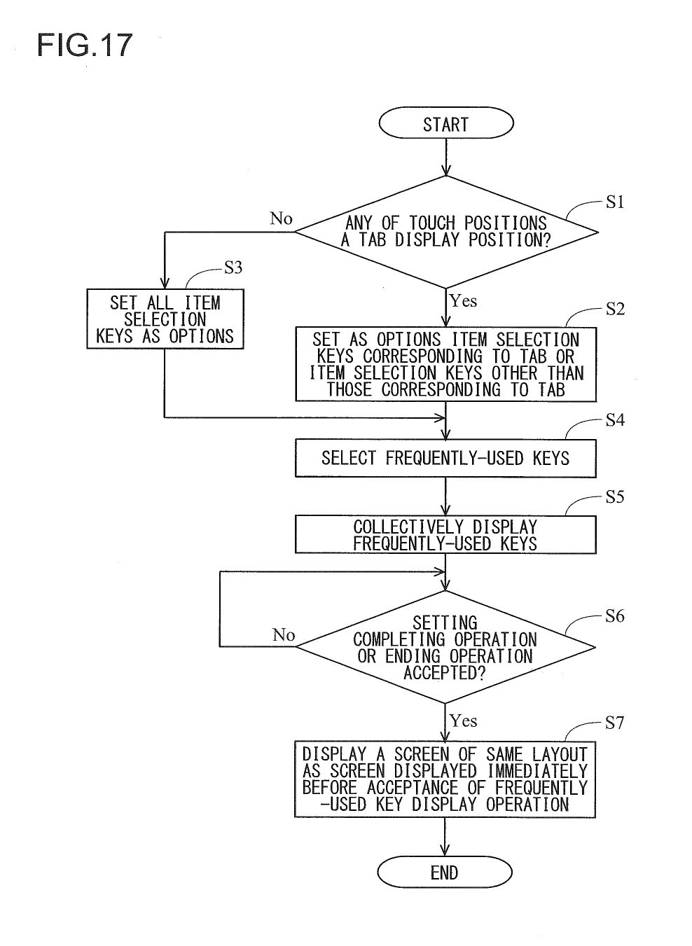

Now a description will be given below of a flow of control performed to collectively display frequently-used keys, with reference to the flowchart illustrated in FIG. 17. Here, it is assumed that the display unit 72 is displaying an item selection screen 8 at the start of the flowchart illustrated in FIG. 17. Processing of the flowchart illustrated in FIG. 17 starts to be performed when a frequently-used key display operation is performed on the touch panel 73.

In step S1, the panel control unit 120 judges whether or not any of a plurality of touched positions is a position where one of the tabs TB is displayed. When the result of the judgment is that a position where one of the tabs TB is displayed is a touched position, the flow shifts to step S2; when the result of the judgment is that no position where one of the tabs TB is displayed is a touched position, the flow shifts to step S3.

In the case where the flow has shifted to step S2, the panel control unit 120 sets, as options, item selection keys K to be displayed on an item selection screen 8 corresponding to the touched tab TB (such item selection keys K may sometimes be referred to as tab corresponding keys K). Alternatively, the panel control unit 120 sets, as options, item selection keys K other than the tab corresponding keys K. On the other hand, in the case where the flow has shifted to step S3, the panel control unit 120 sets all the item selection keys K as options.

Thereafter, in step S4, based on the number-of-times information 123, the panel control unit 120 determines the number of times each of the item selection keys K set as options has been used. And the panel control unit 120 selects frequently-used keys MK which have each been used a large number of times. At this time, the panel control unit 120 selects, as frequently-used keys MK, item selection keys K ranging from an item selection key K of the highest order that has been used the largest number of times to an item selection key K of a predetermined order (for example, the fifth order).

Then, in step S5, the panel control unit 120 makes the display unit 72 perform collective display of the frequently-used keys MK. At this time, the display unit 72 moves item selection keys K other than the frequently-used keys MK to prevent overlapping of the frequently-used keys MK and the other item selection keys K.

Next, in step S6, the panel control unit 120 judges whether or not the touch panel unit 73 has accepted a setting-completing operation or an end operation. When the result of the judgment is that the touch panel unit 73 has accepted a setting-completing operation or an end operation, the flow shifts to step S7; when the result of the judgment is that the touch panel unit 73 has not accepted a setting-completing operation or an end operation, judgment operation of step S6 is repeated. Then, when the flow shifts to step S7, the panel control unit 120 makes the display unit 72 display the item selection screen 8 having the same layout as the screen displayed immediately before the acceptance of the frequently-used key display operation.

As has been described above, the operation panel 7 (a display input device) of the present embodiment includes the display unit 72 that displays a screen, the touch panel unit 73 for detecting a touch operation performed on the screen displayed on the display unit 72, the panel control unit 120 (a control unit) that detects a touch operation performed on the screen displayed on the display unit 72 based on the output of the touch panel unit 73 and makes the display unit 72 switch the screen to another screen, and the panel storage unit 122 (a storage unit) in which the number of times each of the previously determined item selection keys K (soft keys) that can be displayed on the screen displayed on the display unit 72 has been used. Here, when a frequently-used key display operation, which is a touch operation of touching a plurality of points on the screen displayed on the display unit 72, is performed on the touch panel unit 73, the panel control unit 120 selects, as frequently-used keys MK, item selection keys K ranging from an item selection key K of the highest order that has been used the largest number of times to an item selection key K of a predetermined order, and the display unit 72 collectively displays the frequently-used keys MK on the currently displayed screen.

With the configuration of the present embodiment, when a frequently-used key display operation is performed on the touch panel unit 73, frequently-used keys MK are collectively displayed on the display unit 72. Here, the collectively displayed frequently-used keys MK are the item selection keys K ranging from the item selection key K of the highest order that has been used the largest number of times to the item selection key of the predetermined order, and are item selection keys K of high usage frequency which have been repeatedly used in the past. Thus, when it is desired to use an item selection key K of high usage frequency which has been repeatedly used in the past, by performing the frequently-used key display operation just one time, the desired item selection key K is displayed as one of the frequently-used keys MK displayed on the screen in a collective manner. This helps achieve a more user-friendly search for a desired item selection key K among a plurality of item selection keys K.

Furthermore, in the present embodiment, as has been described above, when item selection keys K other than frequently-used keys MK are displayed on the currently displayed item selection screen 8, the display unit 72 moves the item selection keys K other than the frequently-used keys K to prevent overlapping of the frequently-used keys MK and the item selection keys K other than the frequently-used keys MK. This configuration makes it easy to secure a display area for displaying the frequently-used keys MK.

Moreover, in the present embodiment, as has been described above, the panel control unit 120 selects, as frequently-used keys MK, as many item selection keys K as a plurality of touch points touched in a frequently-used key display operation, and the display unit 72 displays the frequently-used keys MK such that the frequently-used keys MK and the plurality of touch points touched in the frequently-used key display operation overlap with each other on a one-to-one basis. This configuration facilitates distinction between frequently-used keys MK and item selection keys other than the frequently-used keys MK.

Furthermore, in the present embodiment, as has been described above, when a touch operation of touching a frequently-used key MK is performed on the touch panel unit 73 while an item selection screen 8 is displayed on which frequently-used keys MK are collectively displayed, the display unit 72 displays an advanced setting screen 9 corresponding to the frequently-used key MK that has received the touch operation. Thereafter, when switching the display screen from the advanced selling screen 9 back to the previously displayed item selection screen 8, the display unit 72 does not perform collective display of frequently-used keys MK. With this configuration, no special operation for ending the collective display of the frequently-used keys MK is required in order to return the display screen to the item selection screen 8 on which collective display of frequently-used keys MK is not performed, and this is convenient to the user.

Moreover, in the present embodiment, as has been described above, when a touch operation previously determined as the end operation is performed on the touch panel unit 73 while an item selection screen 8 is displayed on which frequently-used keys MK are collectively displayed, the display unit 72 ends the collective display of the frequently-used key MK. Here, when the same operation as the frequently-used key display operation is performed again while the display unit 72 is displaying the item selection screen 8 on which the frequently-used keys are collectively displayed, the touch panel unit 73 accepts the operation same as the frequently-used key display operation as an end operation. This configuration makes it easy to return the display screen to the item selection screen 8 on which collective display of frequently-used keys MK is not performed.

Furthermore, in the present embodiment, as has been described above, when any of a plurality of touch positions is a position where one of the tabs TB is displayed, the panel control unit 120 selects frequently-used keys MK from among item selection keys K to be displayed on an item selection screen 8 corresponding to the tab TB, or from among item selection keys other than the item selection keys K to be displayed on the item selection screen 8 corresponding to the tab TB. This configuration makes it possible to prevent unnecessary item selection keys K from being selected as frequently-used keys MK.

It should be understood that the embodiments disclosed herein are merely illustrative in all respects, and should not be interpreted restrictively. The range of the present disclosure is shown not by the above descriptions of embodiments but the scope of claims for patent, and it is intended that all modifications within the meaning and range equivalent to the scope of claims for patent are included.

What is claimed is:

1. A display input device comprising:
a display unit that displays a screen;
a touch panel unit for detecting a touch operation performed on the screen displayed on the display unit;
a control unit that detects a touch operation performed on the screen displayed on the display unit based on an output of the touch panel unit and makes the display unit switch the screen to another screen; and
a storage unit that stores therein number-of-times information that indicates number of times each of previously determined soft keys has been used,
wherein
when a frequently-used key display operation which is a touch operation of touching a plurality of points on the screen displayed on the display unit is performed on the touch panel unit,
the control unit selects, based on the number-of-times information, soft keys ranging from a soft key of a highest order that has been used a largest number of times to a soft key of a predetermined order as frequently-used keys, and
the display unit collectively displays the frequently-used keys on the screen that is currently displayed.

2. The display input device according to claim 1,
wherein
in a case where a soft key among the soft keys that has not been selected as the frequently-used keys is displayed on the currently displayed screen, the display unit moves the soft key that has not been selected as the frequently-used keys to prevent overlapping of the soft key that has not been selected as the frequently-used keys with the frequently-used keys.

3. The display input device according to claim 1,
wherein
the control unit selects, as the frequently-used keys, as many soft keys from among the soft keys as the plurality of touch points touched in the frequently-used key display operation, and
the display unit displays the frequently-used keys such that the frequently-used keys and the plurality of touch points touched in the frequently-used key display operation overlap with each other on a one-to-one basis.

4. The display input device according to claim 1,
wherein
when a touch operation of touching a frequently-used key of the frequently-used keys is performed on the touch panel unit while the display unit is displaying the screen on which the frequently-used keys are collectively displayed, the display unit displays a screen corresponding to the frequently-used key that has received the touch operation, and
the display unit does not perform collective display of the frequently-used keys when switching the screen corresponding to the frequently-used key to an original screen.

5. The display input device according to claim 1,
wherein
when a touch operation previously determined as an end operation is performed on the touch panel unit while the screen is displayed on which the frequently-used keys are collectively displayed, the display unit ends collective display of the frequently-used keys.

6. The display input device according to claim 5,
wherein
when a same operation as the frequently-used key display operation is performed again while a screen is displayed on which the frequently-used keys are collectively displayed, the touch panel unit accepts the same operation as the frequently-used key display operation as the end operation.

7. The display input device according to claim 1,
wherein
the display unit displays a tab on the screen, and the display unit displays a screen corresponding to the tab when a touch operation of touching the tab is performed on the touch panel unit, and
when any of a plurality of touch positions touched in the frequently-used keys display operation is a position where the tab is displayed, the control unit selects the frequently-used keys from among the soft keys to be displayed on the screen corresponding to the tab.

8. The display input device according to claim 1,
wherein
the display unit displays a tab on the screen, and when a touch operation of touching the tab is performed on the touch panel unit, the display unit displays a screen corresponding to the tab, and
when any of a plurality of touch positions touched in the frequently-used keys display operation is a position where the tab is displayed, the control unit selects the frequently-used keys from among the soft keys other than the soft keys to be displayed on the screen corresponding to the tab.

9. An image forming apparatus comprising the display input device according to claim 1.

10. A method for controlling a display input device, the method comprising the steps of:
displaying a screen;
selecting soft keys ranging from a soft key of a highest order that has been used a largest number of times to a soft key of a predetermined order, as frequently-used keys, from among previously determined soft keys, based on number-of-times information that indicates number of times each of the previously determined soft keys has been used, when a frequently-used key display operation is performed which is an operation of touching a plurality of points on the screen; and
collectively displaying the frequently-used keys on the screen that is currently displayed.
